(19) United States
(12) Patent Application Publication
(10) Pub. No.: US 2006/0026247 A1
(43) Pub. Date: Feb. 2, 2006

(54) Communication terminal apparatus

(76) Inventor: Toshifumi Shobu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/186,908

(22) Filed: Jul. 22, 2005

(30) Foreign Application Priority Data
Jul. 28, 2004 (JP) 2004-219682

(51) Int. Cl. G06F 15/16

(52) U.S. Cl. 709/206

(57) ABSTRACT

A print-mode storing unit presets print-mode setting information corresponding to print-mode determination information that is included in the document data, and stores the print-mode setting information preset. A mail receiving unit receives the electronic mail including the document data. A print control unit obtains, from the print-mode storing unit, the print-mode setting information corresponding to the print-mode determination information included in the document data received, and prints out the document data in a print mode based on the print-mode setting information obtained.

### CROSS-REFERENCE TO RELATED APPLICATIONS

The present document incorporates by reference the entire contents of Japanese priority document, 2004-219682 filed in Japan on Jul. 28, 2004.

### BACKGROUND OF THE INVENTION

1. Field of the Invention

The present invention relates to a communication terminal apparatus, and more particularly to a communication terminal apparatus that prints out document data received via an electronic mail (e-mail).

2. Description of the Related Art

In communications of e-mails via a network, such as the Internet, document data in various formats can be attached by coding into text data with a predetermined coding scheme such as a multipurpose internet-mail extension (MIME).

In communication of an attached file between personal computers (PCs) by an e-mail, the attached file is communicated based on agreement in types of a document creation application, such as word processing software, spreadsheet software, and desktop publishing software that is installed in the PCs of a sender and a receiver.

On the other hand, as an alternative facsimile to a conventional group 3 (G3) facsimile or group 4 (G4) facsimile, a network facsimile has rapidly come into wide use in recent years. The network facsimile is designed to use a communication medium of which communication fee is free or extremely low, such as the Internet, for a purpose of reducing communication cost.

The network facsimile includes a real-time network facsimile compliant with international-telecommunication-union telecommunication (ITU-T) recommendation T.38 and an e-mail-type network facsimile compliant with ITU-T recommendation T.37. The real-time network facsimile performs communication while mapping a G3 protocol into a network protocol. The e-mail-type network facsimile performs communication of text data by an e-mail.

In the communication of data via a network using e-mails, a format of an attached file is not limited. It is important that the receiver of the data has an application that is equivalent to a document creation application used to create the data, and that can properly handle the attached file.

On the other hand, in the communication of data between the e-mail-type network facsimiles, a priority is put on sending data without fail. Therefore, a format of a file that can be communicated is limited to tagged-image-file format (TIFF), and other formats are not accepted.

However, according to a demand for higher performance of the communication terminal apparatus, a communication terminal apparatus that accepts an attached file in a format other than the TIFF without causing a reception error, and that expands the attached file into a bitmap format corresponding to a format of the attached file to print out on a recording paper has been developed.

Representative examples of the formats other than the TIFF are a joint photographic experts group (JPEG) and a portable document format (PDF). If files in such formats are sent, in most cases, the files are sent from an ordinary PC, unlike a file in the TIFF, which is a format usually used for data communicated between the e-mail-type network facsimiles. There are conditions to be considered that are specific to facsimile communications. If the communication terminal apparatuses of both the sender and the receiver are the network facsimile compliant with ITU-T recommendation T.37 and the like, such conditions are adequately considered. However, if the communication terminal apparatuses includes a PC, because a document creation application executed on the communication terminal apparatus (PC) of the sender, or a user of the communication terminal apparatus do not pay enough attention to the conditions, files received by the receiver includes attached file in the JPEG and the PDF in addition to files in the TIFF, which are received from the e-mail-type network facsimile. When the communication terminal apparatus prints out document data in the files regardless of types of formats, various kinds of documents printed out cannot be distinguished therebetween. Such a problem is significant when the communication terminal apparatus is the PC.

When the communication terminal apparatus is the network facsimile at a side of the sender, information, such as a time of transmission, a name of a transmission source, a mark for identifying the first page embedded in the first page of the document, for easily distinguishing the documents to be printed out can be embedded in the document data. However, if the communication terminal apparatus is the PC or the like at the side of the sender, the document data to be transmitted is of a common document creation application, which is not intended to be transmitted to the network facsimile. Therefore, such information is not always embedded in the data as header or footer information because whether the information is embedded depends on functions and settings of the communication terminal apparatus at the side of the sender.

Although such information can be embedded at a side of the receiver by the communication terminal apparatus before printing out the document data, if the information is embedded unconditionally, various problems can be caused such that a part of the document data is lost, or appearance of the document to be printed is degraded.

In a technology disclosed in Japanese Patent Application Laid-Open No. 2000-305866, information is added as header information to an attached file to be transmitted at the side of the sender. However, the information added is not always information desired by the receiver. The information can cause inconvenience by adding unnecessary information to the document to be printed out.

Moreover, a technology disclosed in Japanese Patent Application Laid-Open No. 2003-058472 relates merely to determination whether document data that is received via an e-mail can be printed out and to a processing for the determination, and the technology does not relate to printing in a mode optimal for each document data received.

### SUMMARY OF THE INVENTION

It is an object of the present invention to solve at least the above problems in the conventional technology.

A communication terminal apparatus according to one aspect of the present invention, which prints out document data received via an electronic mail, includes a print-mode storing unit that presets print-mode setting information corresponding to print-mode determination information that is included in the document data, and stores the print-mode setting information preset; a mail receiving unit that receives the electronic mail including the document data; and a print control unit that obtains, from the print-mode storing unit, the print-mode setting information corresponding to the print-mode determination information included in the document data received, and prints out the document data in a print mode based on the print-mode setting information obtained.

A communication terminal apparatus according to another aspect of the present invention, which prints out document data received via an electronic mail, includes a print-mode storing unit that presets print-mode setting information corresponding to an operation for specifying a print mode, and stores the print-mode setting information preset; a mail receiving unit that receives the electronic mail including the document data; a document-data storing unit that stores and accumulates the document data received; and a print control unit that prints out a first page of the document data, when there is an input of a predetermined operation for printing out the document data accompanying the operation for specifying a print mode, obtains, from the print-mode storing unit, the print-mode setting information corresponding to the operation for specifying a print mode, and prints out the document data stored in the document-data storing unit in a print mode based on the print-mode setting information obtained.

A communication terminal apparatus according to still another aspect of the present invention, which prints out document data received via an electronic mail, includes a print-mode storing unit that presets print-mode setting information corresponding to a key for an operation for printing out, and stores the print-mode setting information preset; a mail receiving unit that receives the electronic mail including the document data; a document-data storing unit that stores and accumulates the document data received; and a print control unit that prints out a first page of the document data, when there is an input of the key for the operation for printing out the document data, obtains, from the print-mode storing unit, the print-mode setting information corresponding to the key for the operation for printing out, and prints out the document data stored in the document-data storing unit in a print mode based on the print-mode setting information obtained.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a communication system including a communication terminal apparatus according to an embodiment of the present invention;

FIG. 2 is a block diagram of the communication terminal apparatus according to the embodiment;

FIG. 3 is a schematic of an operation/display unit included in the communication terminal apparatus shown in FIG. 2;

FIG. 4 is a schematic for illustrating a protocol stack in the communication terminal apparatus shown in FIG. 2;

FIG. 5 is a schematic for illustrating contents stored in an electronically-erasable-and-programmable read-only-memory (EEPROM) in the communication terminal apparatus shown in FIG. 2;

FIG. 6 is a schematic of a source-address/print-mode table;

FIG. 7 is a schematic of an attached-file-format/print-mode table;

FIG. 8 is a schematic for illustrating contents stored in a random-access memory (RAM) in the communication terminal apparatus shown in FIG. 2;

FIG. 9 is a flowchart of a mail reception processing in the communication terminal apparatus shown in FIG. 2;

FIGS. 10A to 10D are schematics for illustrating examples of a mail header;

FIG. 11 is a schematic of a recording paper printed out that includes various kinds of additional information;

FIG. 12 is a schematic for illustrating contents stored in the EEPROM in the communication terminal apparatus shown in FIG. 2;

FIG. 13 is a flowchart of an e-mail reception process in the communication terminal apparatus shown in FIG. 2; and

FIG. 14 is a flowchart of a registration processing for a print-mode-specifying operation.

### DETAILED DESCRIPTION OF THE PREFERRED EMBODIMENTS

Exemplary embodiments of a communication terminal apparatus according to the present invention will be explained in detail below with reference to the accompanying drawings.

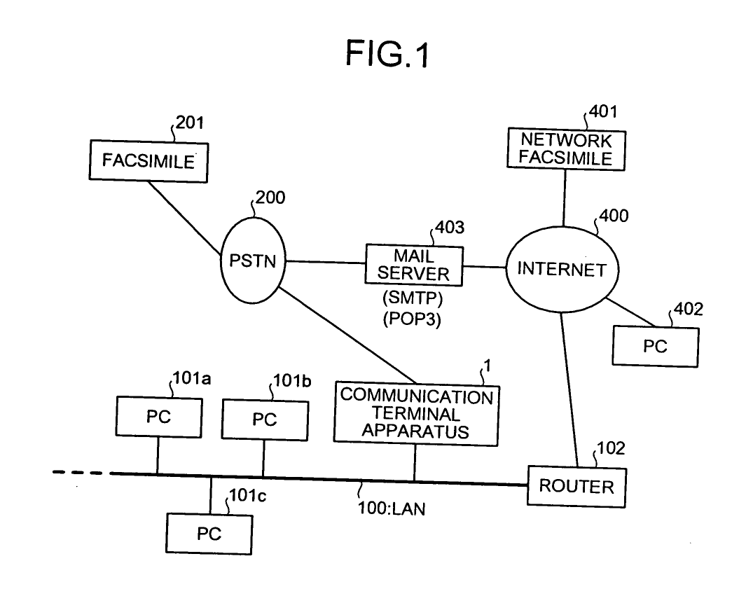

FIG. 1 is a schematic of a communication system including a communication terminal apparatus 1 according to an embodiment of the present invention. As shown in FIG. 1, the communication terminal apparatus 1 can be connected to a public switched telephone network (PSTN) 200. The communication terminal apparatus 1 has such a function that document data can be communicated with a facsimile 201, which is the G3 facsimile on the PSTN 200, by a facsimile communication via the PSTN 200. The communication terminal apparatus 1 also has a function as a dial-up mail terminal that can transmit and receive an e-mail via an internet 400. The communication terminal apparatus 1 controls a point-to-point protocol (PPP) by exchanging high-level data-link-control procedure (HDLC) frames using modem signals between the communication terminal apparatus and a mail server 403 via the PSTN 200. Thus, communication based on a transmission control protocol (TCP)/user datagram protocol (UDP)/internet protocol (IP) on the PPP, and simple mail transfer protocol (SMTP) and post office protocol version 3 (POP3), which are superior to the TCP/DUP/IP is possible.

Moreover, the communication terminal apparatus 1 is connected to a local area network (LAN) 100 as well as personal computers (PC) 101a, 101b, and 101c. By connecting the LAN 100 to the internet 400 through a router 102, the communication terminal apparatus 1 functions as a network facsimile that can communicate document data with a network terminal on the internet 400. The network terminal includes a network facsimile 401 compliant with ITU-T recommendation T.37 performing network facsimile communication in a mail format, and a PC 402 that can create image data and document data using various types of application software and that can transmit and receive the image data and the document data.

The communication terminal apparatus 1 accesses an SMTP server that is provided by an internet service provider, with which an administrator of the communication terminal apparatus 1 has a contract, as an SMTP client to send an e-mail. Moreover, the communication terminal apparatus 1 accesses a POP3 server as a POP3 client to receive an e-mail stored in a mail box for the communication terminal apparatus 1. The mail server 403 on the internet 400 serves as the SMTP server and the POP3 server for the communication terminal apparatus 1. The network facsimile 401 and the PC 402 with which the communication terminal apparatus 1 communicate also send and receive an e-mail using a respective mail server.

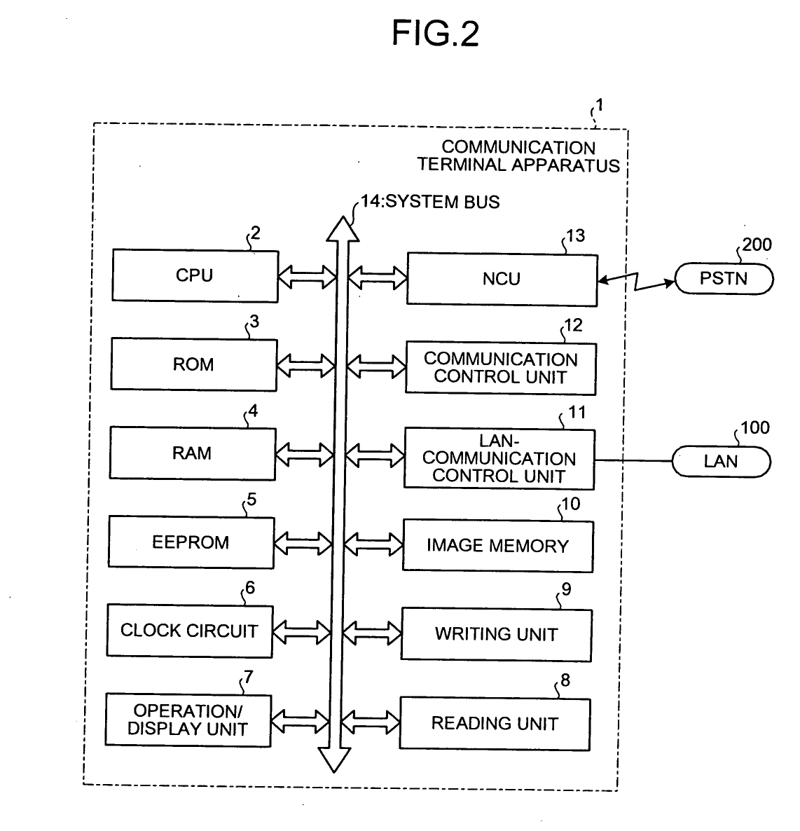

FIG. 2 is a block diagram of the communication terminal apparatus 1. A central processing unit (CPU) 2 shown in FIG. 2 controls various parts of the communication terminal apparatus 1 based on a control program recorded on a read-only memory (ROM) 3, processes various kinds of data, and performs a protocol control, while using a RAM 4 as a work area.

The ROM 3 stores the control program for the CPU 2 to control the various parts of the communication terminal apparatus 1, and various kinds of data that are necessary for controlling font data corresponding to each character code. The RAM 4 is used as the work area of the CPU 2, as described above.

An EEPROM 5 records various information required for an operation of the communication terminal apparatus 1 to retain contents recorded even while the communication terminal apparatus 1 is turned off. The EEPROM 5 may be replaced with a static RAM (SRAM) of which a battery is backed-up or a magnetic disk device.

A clock circuit 6 times a current date and time at all times. The CPU 2 obtains the current date and time by reading from the clock circuit 6.

An operation/display unit 7 includes various keys and a display such as a liquid crystal display. The various keys are used by a user to input an operation. The display displays an operational state to be informed to the user, and various messages.

A reading unit 8 reads a source document to obtain image data of the source document. A writing unit 9 outputs document data that is expanded into the bitmap format to print on a recording paper.

An image memory 10 is a large-scale storage unit that temporarily stores document data not yet processed. The image memory 10 stores received e-mails (including document data as an attached file) that are not yet processed and facsimile document data that is not yet sent to a destination.

A LAN-communication control unit 11 is a network interface card (NIC), and is connected to the LAN 100 to perform communication based on a TCP/IP on an Ethernet protocol. Thus, the LAN-communication control unit enables communication of various kinds of information based on the SMTP and POP3, which are superior to the TCP/IP.

A communication control unit 12 is connected to the PSTN 200 through a network control unit (NCU) 13 to control communication with other communication terminals. The communication control unit 12 controls the NCU 13 and performs detection of pulses of a ringing voltage that is detected in the NCU 13, detection of a dual-tone multi-frequency (DTMF) signal, detection of a tone signal, and origination of a call at a time of transmission. Moreover, the communication control unit 12 includes a modem that demodulates received data, which has been modulated, from other communication terminals and modulates data to be transmitted at the time of transmission. Specifically, the communication control unit 12 includes a low-speed modem (V.21 modem) function for communication of a control signal for the G3 facsimile based on ITU-T recommendation T.30, and each of modem functions of V.17, V.33, V.34, V29, and V.27ter that are high-speed modem functions mainly for communication of the document image data.

The NCU 13 is connected to the PSTN 200 and performs closure of a circuit and detection of a call (ringing) signal.

A system bus 14 is a signal bus that includes a data bus for data communication between components described above, an address bus, a control bus, and an interrupt signal line.

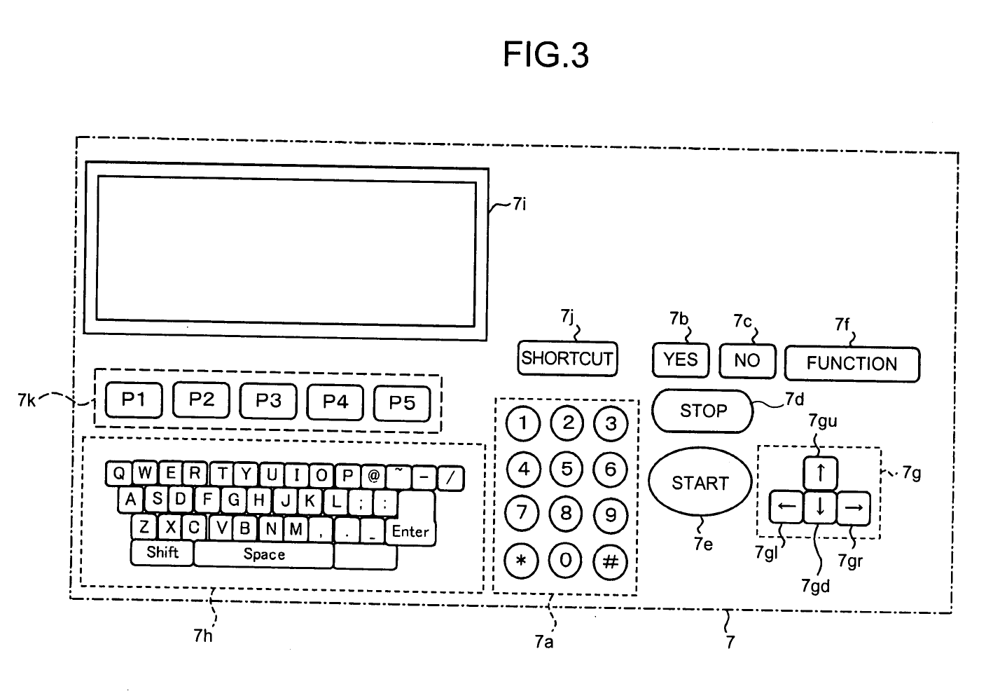

FIG. 3 is a schematic of the operation/display unit 7 in the communication terminal apparatus 1. A numeric key pad 7a is to input each character such as a number, a sharp, and an asterisk. A yes key 7b is to input a positive operation to contents displayed on a display unit 7i. A no key 7c is to input a negative operation to the contents displayed on the display unit 7i.

A stop key 7d is to instruct to forcibly abort an operation. A start key 7e is to instruct to initiate various operations. A function key 7f is used in combination with numeric keys in the numeric key pad 7a. By pressing the function key 7f while pressing a numeric key, various settings and registration functions are invoked.

An arrow key unit 7g includes an up-arrow key 7gu, a down-arrow key 7gd, a right-arrow key 7gr, and a left-arrow key 7gl. The arrow key unit 7g is used to select a specific item from among optional items displayed on the display unit 7i or to scroll a display displayed on the display unit 7i.

A keyboard 7h is used to input an e-mail address. With the keyboard 7h, alphabets and various signs can be input. The display unit 7i is formed with a liquid crystal display and the like, and displays the operational state and the various messages.

A program key unit 7k includes keys of P1 to P5. If a function is set to each of the keys in advance, it is possible to start the function just by pressing a key corresponding to the function. Each of the keys in the program key unit 7k may serve as a printing instruction key according to an embodiment of the present invention.

Keys arranged in the operation/display unit 7 are not limited to mechanical keys, which switches on and off by being pressed, and may be other forms of keys such as touch panel keys, as long as the user can input an operation.

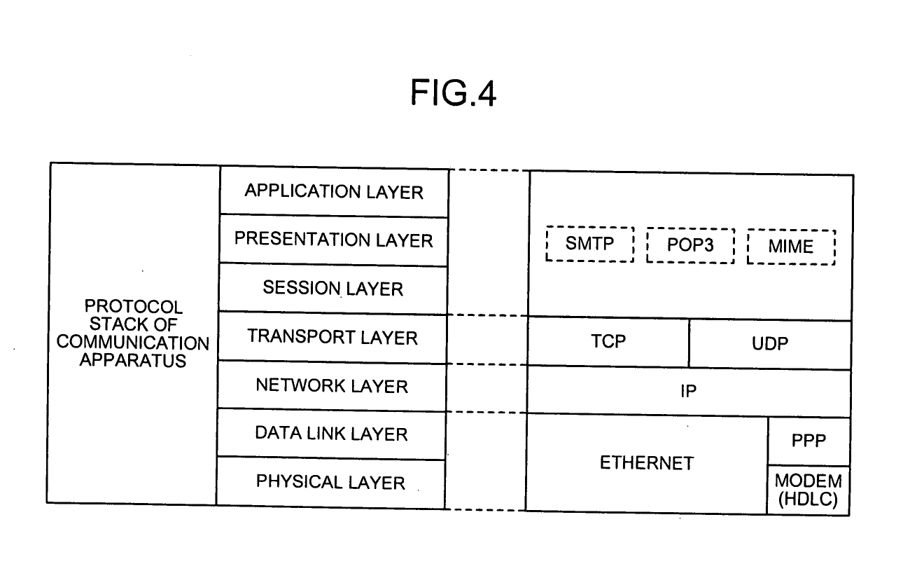

FIG. 4 is a schematic for illustrating a protocol stack in the communication terminal apparatus 1. A physical layer and a data link layer shown in FIG. 4 include an Ethernet that correspond to the LAN-communication control unit 11, and a modem (HDLC) and a PPP that corresponds to the communication control unit 12.

The Ethernet adds a preamble and a start frame delimiter at a top of a media access control (MAC) packet that includes a MAC header and MAC data and that is passed from the IP in a network layer, and adds a frame check sequence FCS at an end of the MAC packet to transmit to the LAN 100 as an electrical signal. The Ethernet also obtains, as digital data, the MAC packet for a MAC address of an own apparatus received as an electrical signal through the LAN 100 to pass to the IP in the network layer.

The IP in the network layer corresponds to a program of the IP that is executed by the CPU 2. The IP in the network layer embeds a TCP (UDP) packet that includes a TCP (UDP) header and TCP (UDP) data and that is passed from a TCP or a UDP in a transport layer as contents of IP data, and embeds an IP packet that is formed by adding an IP header to the IP data as the MAC data or PPP data to pass a MAC packet or a PPP packet that is formed by adding a MAC header or a PPP header to the MAC data or the PPP data, to the Ethernet or the modem, as described above. On the other hand, the IP extracts the IP packet from the MAC data or the PPP data in the MAC packet or the PPP packet that is passed from the Ethernet or the modem to pass to the TCP or the UDP in the transport layer.

The TCP in the transport layer corresponds to a program of the TCP that is executed by the CPU 2. The TCP embeds data passed from an application that is linked to a predetermined port number of a transmission source such as an SMTP client and a POP3 client that form a session layer, a presentation layer, and an application layer as TCP data of a TCP packet that includes a TCP header and TCP data to pass to the IP. The TCP also extracts the TCP packet from the IP packet passed from the IP, and passes the TCP data to a superior application that corresponds to a destination port number written in the TCP header. The UDP and the TCP perform similar operations. In addition to the SMTP client and the POP3 client, the MIME that acts in association with such application protocols is positioned above the TCP/UDP/IP. The MIME encodes document data to embed in a body of an e-mail, and decodes document data that is encoded and included in the body of an e-mail to obtain original document data.

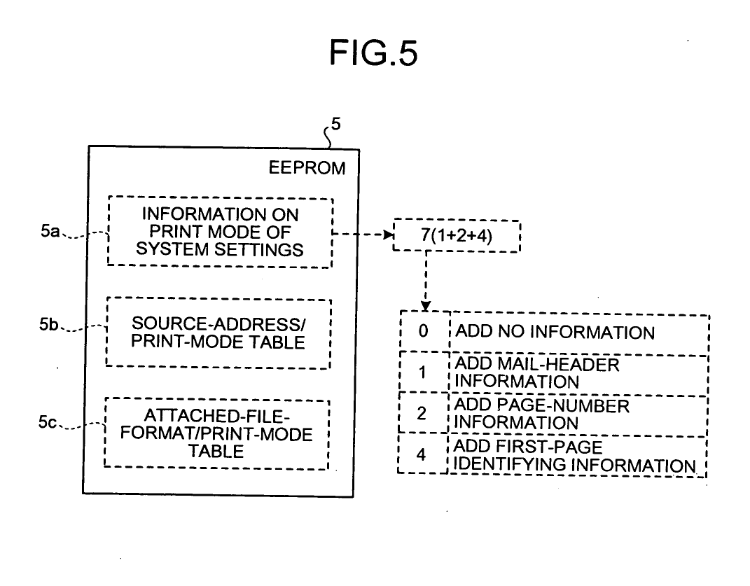

FIG. 5 is a schematic for illustrating contents stored in the EEPROM 5 in the communication terminal apparatus 1. As shown in FIG. 5, the EEPROM 5 includes storage areas 5a, 5b, and 5c that store information on a print mode of system settings, a source-address/print-mode table, and an attached-file-format/print-mode table, respectively.

The information on a print mode of system settings indicates a print mode of a standard setting for the communication terminal apparatus 1. A value “0” indicates a print mode in which document image data is printed without any information added. A value “1” indicates a print mode in which document image data is printed with mail-header information added. A value “2” indicates a print mode in which document image data is printed with page-number information added. A value “4” indicates a print mode in which document image data is printed with first-page identifying information added. The values “1”, “2”, and “4” correspond to the first digit, the second digit, and the third digit in a three-bit binary code respectively. Therefore, if all of the mail-header information, the page-number information, and the first-page identifying information are to be added, it is indicated as “111” (binary system), which is expressed as “7” in a decimal system. In an example shown in FIG. 5, a value “7” is set, and that means “1+2+4”, therefore, all of the mail-header information, the page-number information, and the first-page identifying information are to be added.

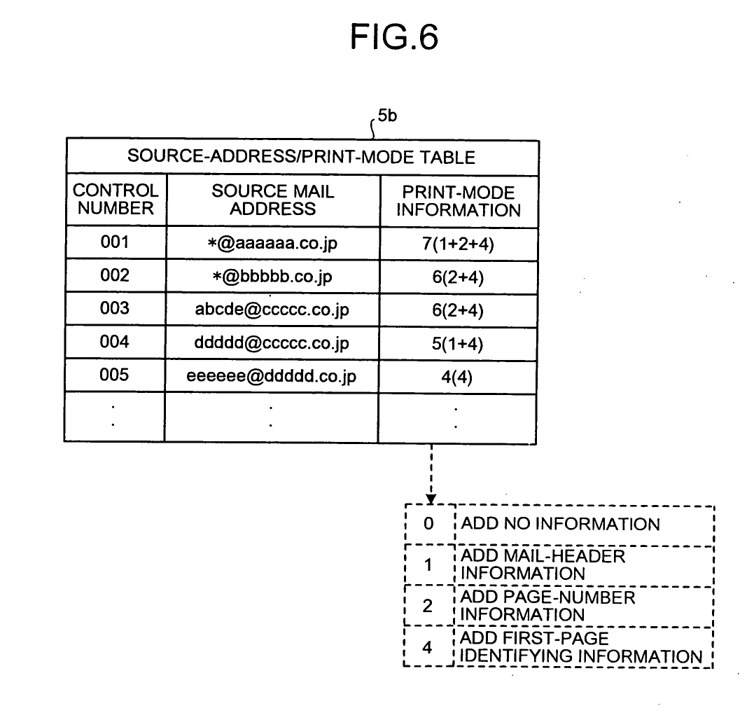

The source-address/print-mode table 5b includes contents as shown in FIG. 6, and is a set of records that includes fields for a source mail address and print-mode information that are associated with a control number. Definition of the print-mode information in the source-address/print-mode table 5b is identical to that of the information on a print mode of system settings in the storage area 5a shown in FIG. 5.

In the source-address/print-mode table 5b, the print-mode information is independently set for each source mail address (document data identified based on each source mail address). A source mail address having “*” as a user name on a left side of an “@” mark indicates that a print-mode corresponding to a domain name indicated on a right side of the “@” of the source mail address is always used for source mail addresses having such domain name, regardless of a user name. The present invention is not limited to correspondence between the source mail address and the print-mode information.

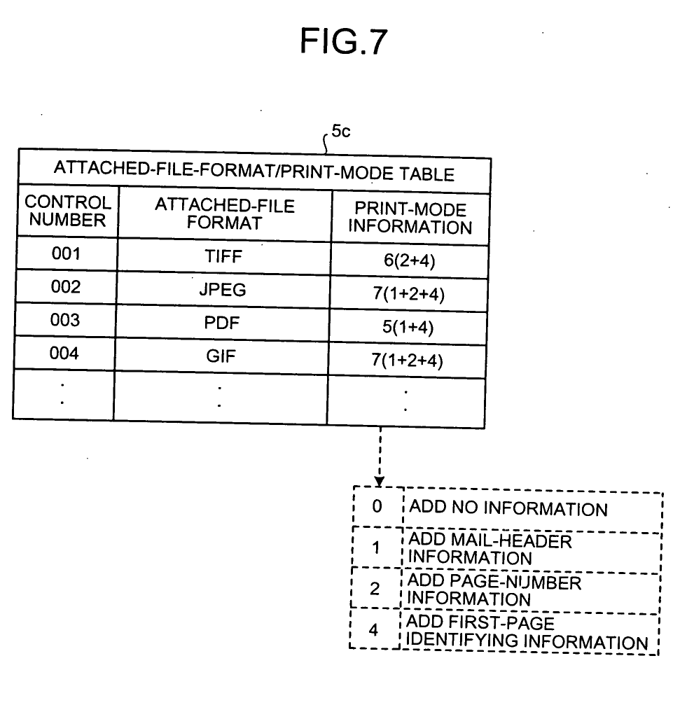

The attached-file-format/print-mode table 5c includes contents as shown in FIG. 7, and is a set of records that includes fields for an attached-file format and print-mode information that are associated with a control number. Definition of the print-mode information in the attached-file-format/print-mode table 5c is identical to that of the information on a print mode of system settings in the storage area 5a shown in FIG. 5.

The attached-file format includes the TIFF, which is a standard format in the network facsimile communication by an e-mail based on ITU-T recommendation T.37, the JPEG format, which is often used for multi tone color or monochrome images handled by a PC, the PDF, which is widely used as an electronic document format, and the GIF, which is often used in communication of color images via a network.

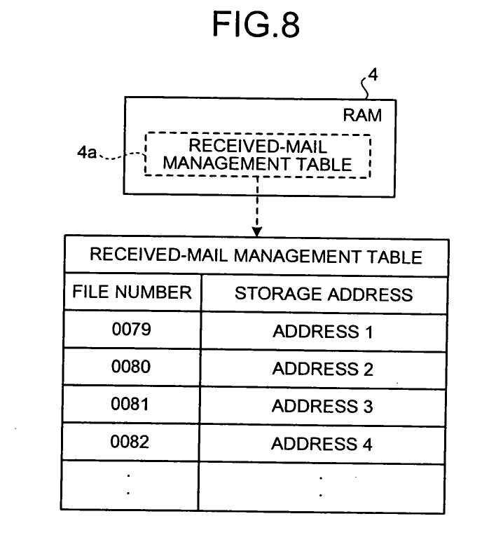

FIG. 8 is a schematic for illustrating contents stored in the RAM 4 in the communication terminal apparatus 1. The RAM 4 shown in FIG. 8 stores a received-mail management table 4a. The received-mail management table 4a is to manage received e-mails not yet processed that are temporarily stored in the image memory 10, and includes a file number and a storage address that are corresponding to each other. The file number is for distinguishing each of the received e-mails, and the storage address is an address of a corresponding e-mail in the image memory 10.

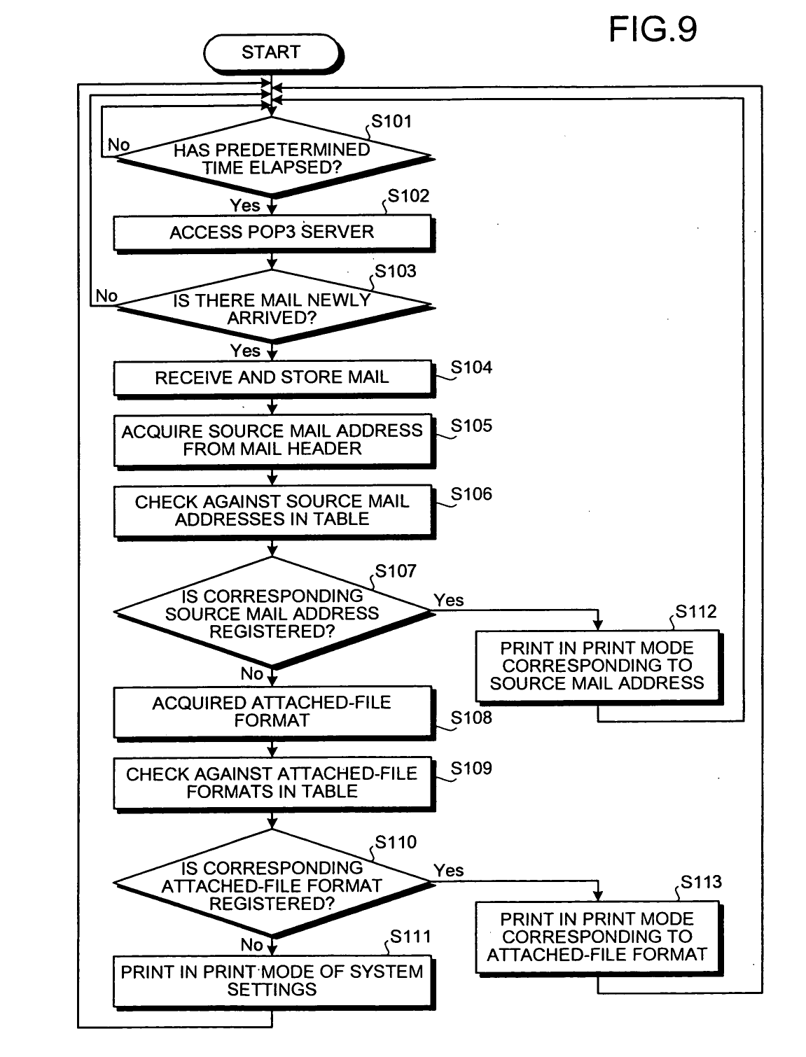

A mail reception processing in the communication terminal apparatus 1 having a structure described above is shown in FIG. 9.

As shown in FIG. 9, the CPU 2 waits until a predetermined time (for example, 15 minutes) of an access interval to the POP3 server (mail server 403 shown in FIG. 1) elapses (“NO” at step S101).

When the predetermined time has elapsed (“YES” at step S101), the CPU 2 accesses the POP3 server based on a POP3 client protocol (step S102), and determines whether there is a mail newly arrived (step S103). When there is no mail (“NO” at step S103), the process returns to step S101.

When there is a mail newly arrived (“YES” at step S103), the mail is received and stored in the image memory 10 (step S104). To the mail stored, a file number is assigned, and a storage address of the mail in the image memory 10 is stored in the received-mail management table 4a shown in FIG. 8 corresponding to the file number.

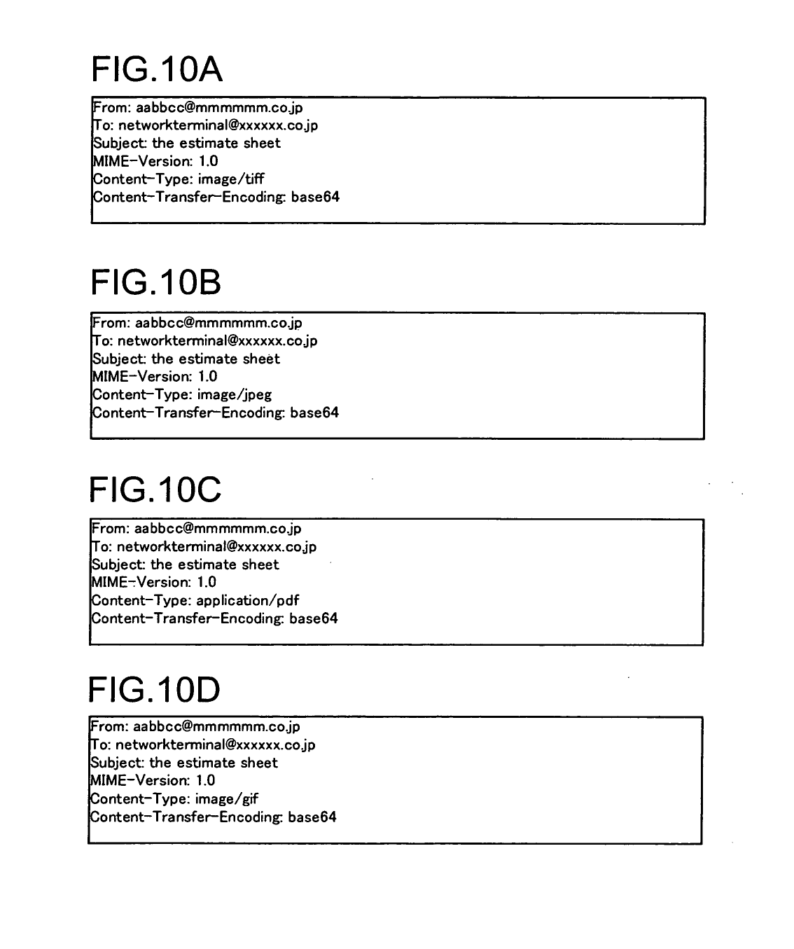

Then, a source mail address is acquired from a description of a from-header in a mail header (examples are shown in FIGS. 10A to 10D) (step S105). The source mail address acquired is checked against source mail addresses in the source-address/print-mode table 5b (step S106). When a source mail address that corresponds to the source mail address acquired is registered in the source-address/print-mode table 5b (“YES” at step S107), document data included in the mail received and stored at step S104 is printed on a recording paper, by the writing unit 9, in a print mode registered corresponding to the source mail address (step S112). After step S112, the process returns to step S101.

When no source mail address that corresponds to the source mail address acquired is registered in the source-address/print-mode table 5b (“NO” at step S107), information on an attached-file format of the mail received and stored at step S104 is acquired (step S108). The attached-file format can be identified from a description of a content-type header in the mail header as shown in FIGS. 10A to 10D. If the description of the content-type header is “multipart/mixed” that indicates that document data of more than one page is included in a body of the mail, the attached-file format can be identified from the content-type header at each message part in the body. Even when the description of the content-type header is “multipart/mixed”, in most cases, the content-type header at each of the message parts has a description indicating a common file format, for example, “image/gif”. However, there may be a case in which the descriptions of the content-type headers indicate different file formats, for example, “image/gif” and “image/jpeg”. In this case, the attached-file format may be set to a file format of a message part having the most pages or the largest data amount. Alternatively, a print mode may be set and registered in advance for such a case that more than one file format is used in a single mail in the attached-file-format/print-mode table 5c.

The attached-file format acquired at step S108 is checked against attached-file formats in the attached-file-format/print-mode table 5c (step S109). When an attached-file format that corresponds to the attached-file format acquired (“YES” at step S110), the document data included in the mail received and stored at step S104 is printed on a recording paper, by the writing unit 9, in a print mode registered corresponding to the attached-file format (step S113). After step S113, the process returns to step S101.

When no attached-file format that corresponds to the attached-file format acquired (“NO” at step S110), the document data included in the mail received and stored at step S104 is printed on a recording paper, by the writing unit 9, in a print mode of system settings (step S111). After step S111, the process returns to step S101.

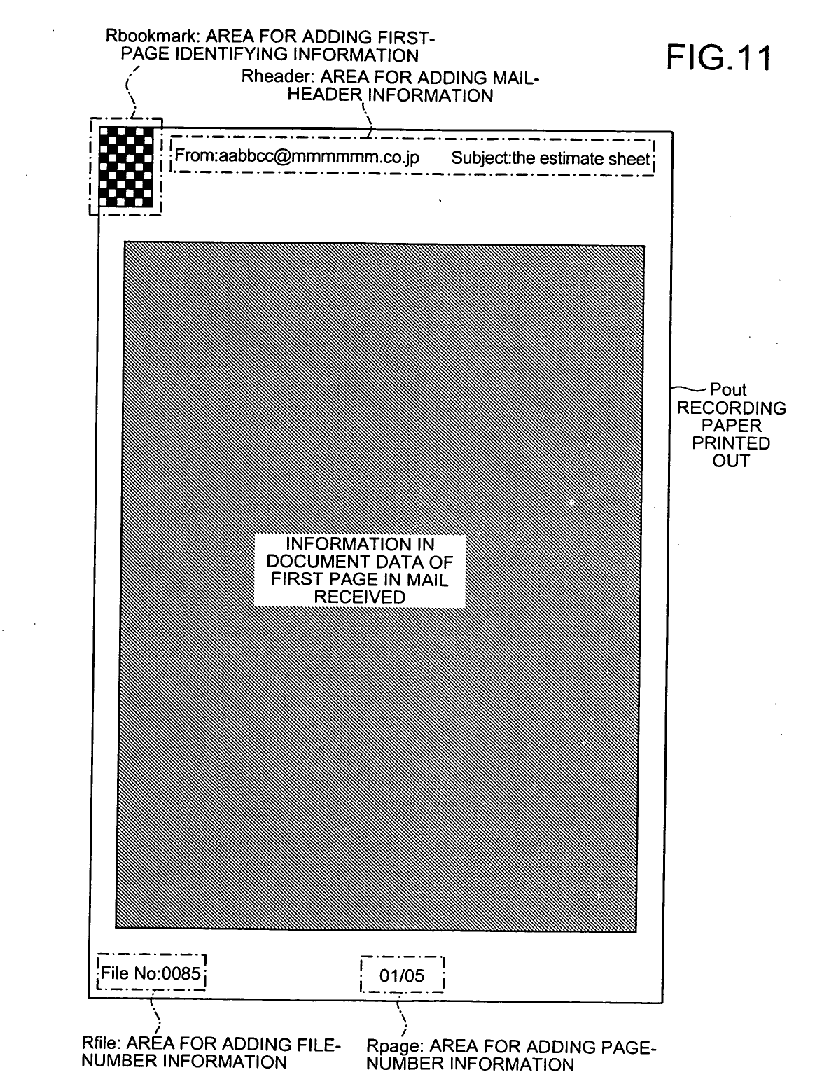

An example of a recording paper printed out at step S112, S113, or S111 when the information on the print-mode indicates a value “7 (1+2+4)” is shown in FIG. 11.

A recording paper Pout shown in FIG. 11 illustrates the first page of document data received that includes at least one-page amount of data. On the recording paper Pout, various kinds of additional information are superimposed on one-page amount of document data and recorded.

Specifically, in an area for adding first-page identifying information Rbookmark, a checkered pattern is added as an identifier that indicates that a page having the checkered pattern is the first page of the document. The first-page identifying information is not added for the second page and later.

In an area for adding mail-header information Rheader, information included in the mail header of an e-mail received is added. In the example shown in FIG. 11, information on the from-header indicating a transmission source and information on a subject-header indicating a subject of the e-mail are added.

In an area for adding file-number information Rfile, a file number (file No.) that corresponds to the file number in the received-mail management table 4a is added. While in the present embodiment, the file number is always printed as additional information regardless of a setting, whether the file number is added may be included in the information on a print mode of system settings to be optional.

In an area for adding page-number information Rpage, information that indicates a page number (“01” in this example) out of total pages (“05” in this example).

Thus, when document data included in an e-mail received is printed out, it is possible to the print document data in a print mode in which the document data is printed with additional information optimal for the document data (depending on a transmission source or a file format).

While in the mail reception processing shown in FIG. 9, the print mode corresponding to the source mail address has precedence over the print mode corresponding to the file format, order of precedence may be opposite. The order of precedence may also be set by a user so that the order of precedence is changeable, thereby responding to demands of each user of the communication terminal apparatus 1.

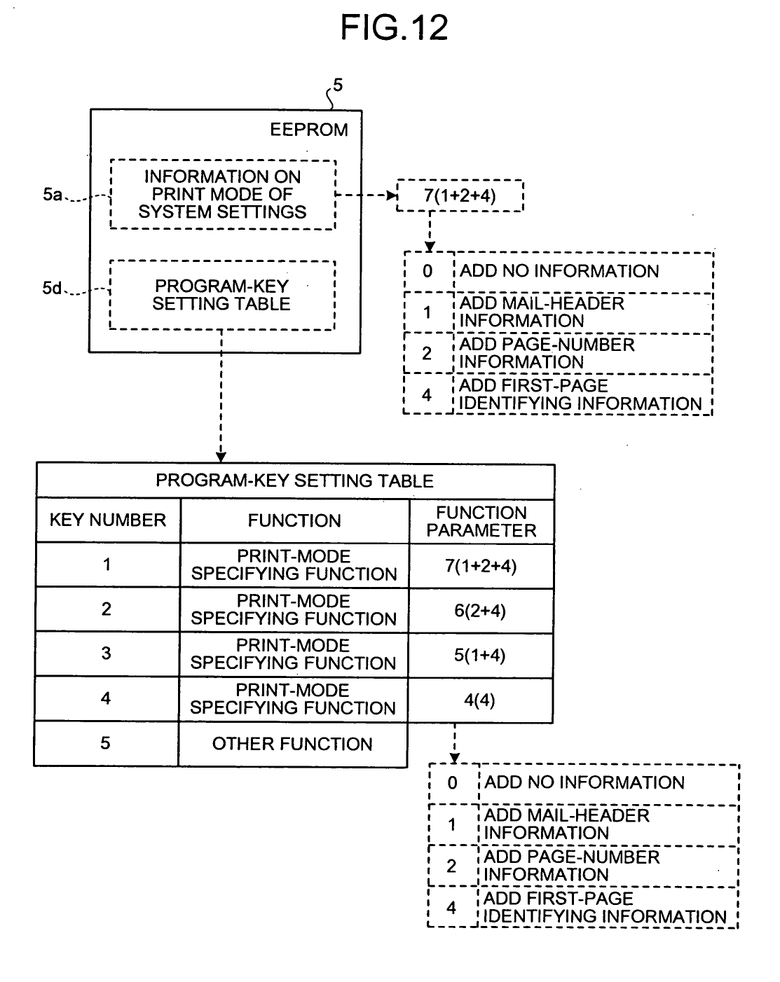

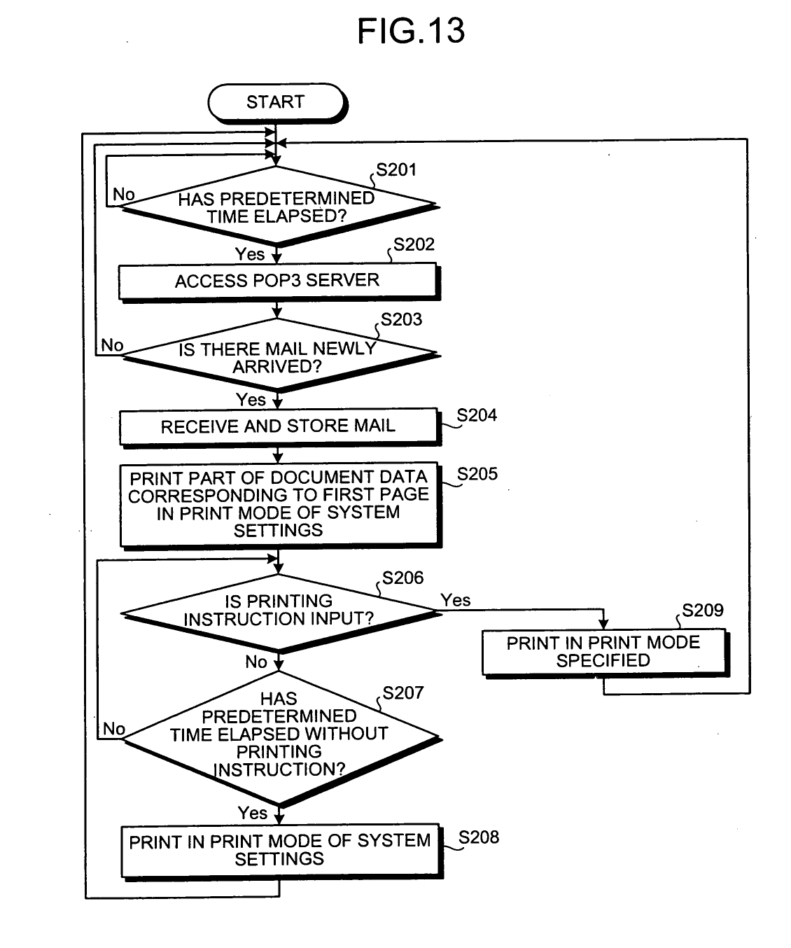

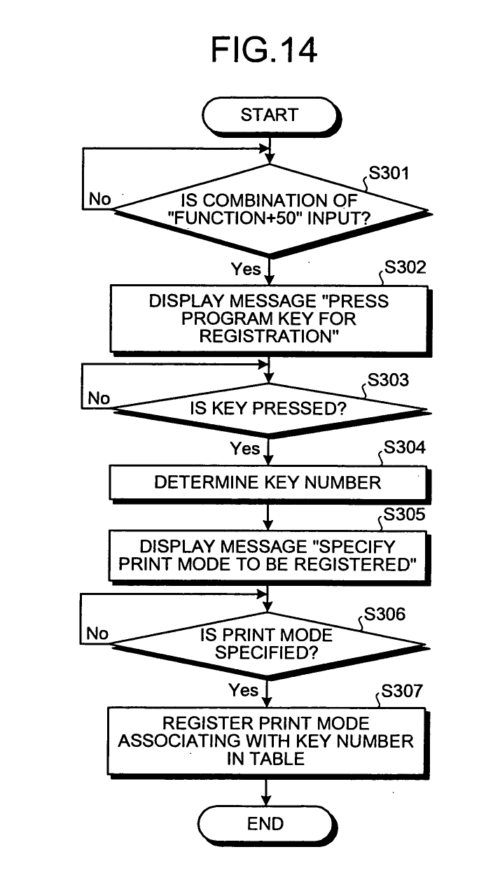

As a modification of the exemplary embodiment of the present invention explained above, instead of the contents stored in the EEPROM 5 shown in FIG. 5, contents shown in FIG. 12 may be applied. Moreover, instead of the mail reception processing shown in FIG. 9, a mail reception processing shown in FIG. 13 may be performed. Furthermore, for setting of a program-key setting table 5d in the EEPROM 5 shown in FIG. 12, a print-mode specification processing shown in FIG. 14 may be performed.

Among the contents stored in the EEPROM 5 shown in FIG. 12, while the storage area 5a stores information on a print mode of system settings, which is identical to the contents stored in the storage area 5a shown in FIG. 5, the source-address/print-mode table 5b and the attached-file-format/print-mode table 5c are replaced with the program-key setting table 5d.

The program-key setting table 5d includes information on a function and a function parameter corresponding to the function. The key numbers “1” to “5” correspond to the keys P1 to P5 in the program key unit 7k in the operation/display unit 7 shown in FIG. 3 respectively. The function is set corresponding to each of the keys P1 to P5.

For each of the key numbers “1” to “4”, a print-mode specifying function is set as the function, and a value that indicates a print mode similarly defined as the information on a print-mode of system settings is set as the function parameter. For the key number “5”, a function other than the print-mode specifying function is set.

As shown in FIG. 13, the CPU 2 waits until a predetermined time (for example, 15 minutes) of an access interval to the POP3 server (mail server 403 shown in FIG. 1) elapses (“NO” at step S201).

When the predetermined time has elapsed (“YES” at step S201), the CPU 2 accesses the POP3 server based on the POP3 client protocol (step S202), and determines whether there is a mail newly arrived (step S203). When there is no mail (“NO” at step S203), the process returns to step S201.

When there is a mail newly arrived (“YES” at step S203), the mail is received and stored in the image memory 10 (step S204). To the mail stored, a file number is assigned, and a storage address of the mail in the image memory 10 is stored in the received-mail management table 4a shown in FIG. 8 corresponding to the file number.

Then, a portion of document data that corresponds to the first page among document data in the mail stored at step S204 is printed on a recording paper, by the writing unit 9, in the print mode of system settings stored in the storage area 5a shown in FIG. 12 (step S205). If the print-mode of system settings has the value “7 (1+2+4)”, all the additional information possible to be superimposed is added as shown in FIG. 11. Therefore, it is possible to determine necessity of each of the additional information while taking a look at the first page of a document printed. There may be various output patterns for confirming contents of the document data received other than printing out the first page. For example, a preview of the document data may be displayed on the display unit 7i, or the document data may be printed out according to a printing request that includes operations of specifying the file number and the page number by a user. Furthermore, the mail-header information and the file-format information of the document data may be displayed on the display unit 7i as reference information for the user to determine a print mode.

After printing out the first page at step S205, the CPU 2 waits until a printing instruction is input, or until a predetermined time elapses without input of the printing instruction (“NO” at step S206 and “NO” at step S207”).

The printing instruction is input by pressing any one of the keys P1 to P4 in the program key unit 7k. When one of the keys P1 to P4 is pressed (“YES” at step S206), all of the document data included in the mail received and stored at step S204 is printed on a recording paper, by the writing unit 9, in a print mode indicated by a function parameter that corresponds to the key pressed (step S209). After step S209, the process returns to step S201.

When the predetermined time has elapsed without input of the printing instruction at step S207, all of the document data is printed, by the writing unit 9, in the print mode of system settings stored in the storage area 5a (step S208) because if nothing is done, the document data is never to be printed except for the first page. After step S208, the process returns to step S201.

Thus, it is possible to let a user confirm additional information to be added to document data by printing only a part of the document data to be the first page, thereby enabling to add additional information optimal for the document data. Moreover, if there is no printing instruction that includes designation of a print mode by pressing the program key within a predetermined time, entire part of the document data is forcibly printed out in the print mode of system settings. Therefore, although a system requires an operation by a user for specifying a print mode, even in a case in which such operation is not input, such a problem can be prevented that a function of receiving/printing an e-mail is practically stopped in the communication terminal apparatus, while maintaining convenience of manually specifying a print mode by the user.

When it is determined “NO” at step S207, instead of proceeding to step S208, the process may be proceeded to step S105. In other words, when there is no printing instruction specifying a print mode within the predetermined time, the document data may be printed in a print mode, which is set in advance by the user, corresponding to a source mail address or a file format of the mail received. Whether to proceed to step S208 or to step S105 may be selectable according to a condition desired by the user.

The document data in the image memory 10 may be deleted soon after printing of the document data is completed for a purpose of keeping as much available memory as possible. Alternatively, the document data may be deleted according to deleting instruction input by the user. Such a deleting mode of the document data may be set in advance according to a condition desired by the user.

At steps S208 and S209, the document data may be printed such that without re-printing the part of the document data, which is data of the first page, already printed at step S205, only rest of the document data is printed out. In this case, the first page and other pages from the second page that are printed at different timings can be checked against each other referring to the file-number information, which is information always added. Information to be referred is not limited to the file-number information, and may be other information such as reception time as long as the information to be referred is unique to the document data.

According to the present embodiment, when the program key is pressed to specify a print mode, which is set in advance for the program key, such operation for specifying the print mode is recognized as the printing instruction, thereby simplifying a operation such that an operation to instruct to print the document data and an operation to specify the print mode are not required to be performed separately. The printing instruction may also be input after performing the operation to specify a print mode, although this makes a key operation relatively complicated. In addition, it becomes necessary to prepare a table similar to the tables shown in FIGS. 6 and 7 in which information on a print mode corresponding to an operation to specify a print mode is stored.

When the print-mode specifying function is to be set in the program-key setting table 5d shown in FIG. 12, a registration processing for a print-mode-specifying operation shown in FIG. 14 is performed. As shown in FIG. 14, input of a combination of the function key 7f and a number “50” that is input by pressing the function key 7f and the numeric key pad 7a is waited (“NO” at step S301). When the combination is input (“YES” at step S301), it is determined that a registration mode for a print-mode specifying operation is initiated, and a message “press a program key for registration” is displayed (step S302).

Then, selection of a key from among the keys P1 to P5 in the program key unit 7k by pressing the key is waited (“NO” at step S303). When the key is pressed to be selected (“YES” at step S303), a key number of the key is determined (step S304), and a message “specify a print mode to be registered” is displayed (step S305). Input of a value that indicates a print mode with the numeric key pad 7a based on the definition shown in FIG. 12 is waited (“NO” at step S306). When the value indicating the print mode is input to specify the print mode (“YES” at step S306), the print mode (value) specified is registered associating with the key number in the program-key setting table 5d (step S307).

Thus, it is possible to register a desirable print mode for an arbitrary program key regarding printing of document data received via an e-mail, thereby enhancing convenience at a time of specifying a print mode at step S206 in the mail reception processing shown in FIG. 13.

The exemplary embodiments of the present invention have been explained above. However, it should be noted that the present invention is not limited to the embodiments explained above, and various modifications may be applied without departing from a scope of the present invention.

According to the present invention, it is possible to print document data in a print mode optimal for the document data.

Moreover, according to the present invention, it is possible to print document data in a print mode optimal for a user.

Furthermore, according to the present invention, it is possible to improve operability.

Moreover, according to the present invention, it is possible to obtain convenience of manual input of a print mode while preventing a function of receiving/printing an e-mail from practically being stopped.

Furthermore, according to the present invention, it is possible to add information included in a mail header only when such information is necessary.

Moreover, according to the present invention, it is possible to add information on a page number only when such information is necessary.

Furthermore, according to the present invention, it is possible to add information for identifying the first page only when such information is necessary.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A communication terminal apparatus that prints out document data received via an electronic mail, the communication terminal apparatus comprising:
a print-mode storing unit that presets print-mode setting information corresponding to print-mode determination information that is included in the document data, and stores the print-mode setting information preset;
a mail receiving unit that receives the electronic mail including the document data; and
a print control unit that obtains, from the print-mode storing unit, the print-mode setting information corresponding to the print-mode determination information included in the document data received, and prints out the document data in a print mode based on the print-mode setting information obtained.

2. The communication terminal apparatus according to claim 1, wherein
the print-mode determination information includes a mail address of a sender of the electronic mail, and
the print control unit obtains the print-mode setting information corresponding to the mail address, and prints out the document data in a print mode based on the print-mode setting information obtained.

3. The communication terminal apparatus according to claim 1, wherein
the print-mode determination information includes a format of a file including the document data attached to the electronic mail, and
the print control unit obtains the print-mode setting information corresponding to the format of the file attached to the electronic mail received, and prints out the document data in a print mode based on the print-mode setting information obtained.

4. The communication terminal apparatus according to claim 1, wherein the print-mode setting information includes information on whether to add information on a page number to each page of the document data to be printed out.

5. A communication terminal apparatus that prints out document data received via an electronic mail, the communication terminal apparatus comprising:
a print-mode storing unit that presets print-mode setting information corresponding to an operation for specifying a print mode, and stores the print-mode setting information preset;
a mail receiving unit that receives the electronic mail including the document data;
a document-data storing unit that stores and accumulates the document data received; and
a print control unit that prints out a first page of the document data, when there is an input of a predetermined operation for printing out the document data accompanying the operation for specifying a print mode, obtains, from the print-mode storing unit, the print-mode setting information corresponding to the operation for specifying a print mode, and prints out the document data stored in the document-data storing unit in a print mode based on the print-mode setting information obtained.

6. The communication terminal apparatus according to claim 5, wherein
when there is no input of the predetermined operation for printing out the document data for a predetermined time after printing out the first page of the document data, the print control unit forcibly prints out the document data stored in the document-data storing unit.

7. The communication terminal apparatus according to claim 5, wherein the print-mode setting information includes information on whether to add predetermined information included in a mail header of the electronic mail to the first page of the document data to be printed out.

8. The communication terminal apparatus according to claim 5, wherein the print-mode setting information includes information on whether to add information on a page number to each page of the document data to be printed out.

9. The communication terminal apparatus according to claim 5, wherein the print-mode setting information includes information on whether to add predetermined information indicating that a current page is the first page of the document data to the first page of the document data to be printed out.

10. A communication terminal apparatus that prints out document data received via an electronic mail, the communication terminal apparatus comprising:
a print-mode storing unit that presets print-mode setting information corresponding to a key for an operation for printing out, and stores the print-mode setting information preset;
a mail receiving unit that receives the electronic mail including the document data;
a document-data storing unit that stores and accumulates the document data received; and
a print control unit that prints out a first page of the document data, when there is an input of the key for the operation for printing out the document data, obtains, from the print-mode storing unit, the print-mode setting information corresponding to the key for the operation for printing out, and prints out the document data stored in the document-data storing unit in a print mode based on the print-mode setting information obtained.

11. The communication terminal apparatus according to claim 10, wherein
when there is no input of the predetermined operation for printing out the document data for a predetermined time after printing out the first page of the document data, the print control unit forcibly prints out the document data stored in the document-data storing unit.

12. The communication terminal apparatus according to claim 10, wherein the print-mode setting information includes information on whether to add predetermined information included in a mail header of the electronic mail to the first page of the document data to be printed out.

13. The communication terminal apparatus according to claim 10, wherein the print-mode setting information includes information on whether to add information on a page number to each page of the document data to be printed out.

14. The communication terminal apparatus according to claim 10, wherein the print-mode setting information includes information on whether to add predetermined information indicating that a current page is the first page of the document data to the first page of the document data to be printed out.
